(19) United States
(12) Patent Application Publication
(10) Pub. No.: US 2006/0146153 A1
(43) Pub. Date: Jul. 6, 2006

(54) Method and apparatus for processing Bayer image data

(75) Inventors: Yu Xia, Beijing (CN); Hao Wang, Beijing (CN); Hui Zhang, Mountain View, CA (US); Yu Qing, Beijing (CN)

Correspondence Address: SILICON VALLEY PATENT AGENCY, 7394 WILDFLOWER WAY, CUPERTINO, CA, 95014, US

(73) Assignee: Vimicro Corporation

(21) Appl. No.: 11/331,114

(22) Filed: Jan. 10, 2006

(30) Foreign Application Priority Data
Jan. 1, 2005 (CN) 200510000469.6

(51) Int. Cl. H04N 9/04

(52) U.S. Cl. 348/272

(57) ABSTRACT

Techniques for efficiently processing Bayer image data to generate a final image that realistically and properly reproduce an original scene are disclosed. According to one implementation, a method for processing Bayer images comprises receiving a raw image from a sensor with Bayer color arrays, determining a corresponding dot in the raw image that corresponds to each pixel in a final image, locating color reference pixels in the raw image according to the corresponding dot, selecting interpolation pixels in the raw image according to the color reference pixels, and interpolating color values of the each pixel in the final image according to color values of the interpolation pixels.

### BACKGROUND OF THE INVENTION

1. Field of the Invention

The present invention relates to data processing, particularly to techniques for processing image data to realistically and properly represent original scenes.

2. Description of Related Art

In digital cameras, photograph lens, or the like, Bayer color filter array is popularly provided for capturing color images by transforming scene into discrete pixels. Each pixel has been made sensitive only to one color, for example, green (G), red (R) and blue (B). In general, half of the total number of pixels is G, while a quarter of the total number is assigned to both R and B, respectively.

FIGS. 1a-1d show four different ways for arranging monochrome pixels, which are widely called Bayer color arrays. As shown in FIG. 1a, the pixel sequence of a first row of the Bayer color arrays follows GR alternation while the pixel sequence of an alternating row of the Bayer color arrays follows BG alternation. FIG. 1b, FIG. 1c and FIG. 1d show, respectively, other alternatives of the Bayer color arrays.

The Bayer color arrays or format does not exactly represent the colors of an original scene. Some post-processing or correction of a Bayer image (from the Bayer color format) is necessary to ensure that a final image represents the colors of the original scene as realistically as possible. According to one method, a Bayer format image is converted to a RGB format image by interpolating two missing color values in each pixel of the Bayer image. Each pixel (alternatively referring to as a vector pixel) in the RGB image has three color components, B, R and G. Several standard interpolation methods, such as nearest neighbor, bi-linear, bi-cubic, etc. are used.

After a RGB image is displayed in a display screen of a digital camera, a zooming operation is usually required to finally display the RGB image in a suitable size. As shown in FIG. 2, a conventional method for processing the Bayer image data to realistically and properly display the original scene is illustrated. At 201, the Bayer format image (data) is converted into the RGB format image. As described above, an interpolation method is used in the converting operation. A pixel in FIG. 1a is taken as an example to explain the interpolation method. The pixel itself represents G element. Two neighbor pixels of the pixel along the X axis direction represent R. Two neighbor pixels of the pixel along the Y axis direction represent B. It is supposed that the G value of the pixel is G0, the B values of the two neighbor pixels in the X axis direction are B1 and B2, the R values of the two neighbor pixels in the Y axis direction are R1 and R2, respectively. Thus the R value R0 and the B value B0 is interpolated on the pixel by:

$$\begin{matrix}R 0 = \frac{R 1 + R 2}{2} & ( 1 ) \\ B 0 = \frac{B 1 + B 2}{2} & ( 2 )\end{matrix}$$

The interpolation method adopted in the formulas (1) and (2) is the linear interpolation. Other interpolation methods may also be used, depending on a practical application.

After the interpolation, the pixel has three color values, R0, G0, and B0, where G0 may be set to the original G of the pixel. After all pixels in the Bayer format image are interpolated to generate the two missing colors, the RGB format image can be obtained.

At 202, the RGB format image is zoomed to obtain the RGB image in a suitable size. Interpolation calculations may also be required here to acquire three color values of all pixels of the zoomed RGB image. As an example, the interpolation calculation of a R value of one pixel of the zoomed RGB image is illustrated here to explain the zooming operation.

It is supposed that the size of an un-zoomed RGB image is M×N and the R value of the pixel (i,j) in the un-zoomed RGB image is f(i,j), wherein 0≦i<M,0≦j<N; the size of the zoomed RGB image is M′×N′, and the R value of the pixel (i′,j′) in the zoomed RGB image is f(i′,j′), wherein 0≦i′<M, 0≦j<N′.

Firstly, a corresponding dot (x,y) in the un-zoomed RGB image of the pixel (i′,j′) of the zoomed RGB image is obtained according to:
x=i′M/M′,y=j′N/N′,
where the M′/M, the N′/N represent the zoom factors in the X axis direction and the Y axis direction, respectively.

Secondly, a reference pixel (i,j) in the un-zoomed RGB image of the pixel of the zoomed image is located according to i=└x┘,j=└y┘, namely to integrate x,y downward.

As shown in FIG. 3, distances between the corresponding dot (x,y) and the reference pixel (i,j) in the X axis direction and the Y axis directions are dx=x−i,dy=y−j, respectively, where 0≦dx,dy<1.

Subsequently, several interpolation pixels are selected according to the corresponding dot (x,y) and the reference pixel (i,j). Based on the R values of the selected interpolation pixels, an interpolation method is used to calculate the R value f′(i′,j′) of the pixel (i′,j′) of the zoomed RGB image.

For different interpolation methods, the number and the position of the selected interpolation pixels may be different. If the Bi-Linear method is used, pixels (i,j), (i,j+1), (i+1,j) and (i+1,j+1) shown in FIG. 3 should be selected as the interpolation pixels. Thus, the R value f′(i′,j′) can be calculated according to:
f′(i′,j′)=(1−d)(1−dy)f(i,j)+dy(1−d)f(i,j+1)+dx(1−dy)f(i+1,j)+dxdyf(i+1,j+1) (3)

If the Bi-Cubic method is used, sixteen pixel dots designated in grey in FIG. 3 should be selected. Thus, the R value f′(i′,j′) can be calculated according to:

$${f}^{′} ( {i}^{′} , {j}^{′} ) = {\sum }_{m = - 1}^{2} {\sum }_{n = - 1}^{2} f ( i + m , j + n ) R ( m - dx ) R ( dy - n ) \qquad ( 4 )$$

wherein a weighted coefficient R(x) in the formula (4) can be acquired by the following formula:

$$R ( x ) = \frac{1}{6} [ P {( x + 2 )}^{3} - 4 P {( x + 1 )}^{3} + 6 P {( x )}^{3} - 4 P {( x - 1 )}^{3} ] \\ wherein \\ P ( x ) = \{ \begin{matrix}x & x \geq 0 \\ 0 & x > 0\end{matrix} . \qquad ( 5 )$$

Similarly, the G, B value of each pixel of the zoomed RGB image can be acquired till the whole zoomed RGB image is acquired.

It can be noticed that 2MN times of the interpolation calculations are required to convert the image format at 201, and 3M′N′ times of the interpolation calculation are required for zooming the RGB image at 202, so the total times of interpolation calculation needed in the prior art is 2MN+3M′N′. For an image capturing device with less computing power, it can take a long time to reach the zoomed image. Furthermore, in the operation for converting the image format and zooming the RGB image, no more information is added into the image data. Therefore, multiple interpolation calculations only arise complexity of the calculation without introducing useful image information or benifits.

Thus there is a need for techniques for efficiently processing Bayer image data to realistically and properly display an original scene.

### SUMMARY OF THE INVENTION

This section is for the purpose of summarizing some aspects of the present invention and to briefly introduce some preferred embodiments. Simplifications or omissions in this section as well as in the abstract or the title of this description may be made to avoid obscuring the purpose of this section, the abstract and the title. Such simplifications or omissions are not intended to limit the scope of the present invention.

In general, the present invention pertains to techniques for efficiently processing Bayer image data to generate a final image that realistically and properly reproduce an original scene. According to one aspect of the present invention, a method for processing Bayer images comprises receiving a raw image from a sensor with Bayer color arrays, determining a corresponding dot in the raw image that corresponds to each pixel in a final image, locating color reference pixels in the raw image according to the corresponding dot, selecting interpolation pixels in the raw image according to the color reference pixels, and interpolating color values of the each pixel in the final image according to color values of the interpolation pixels.

According to one embodiment, an apparatus for processing Bayer images comprising an image sensor with Bayer color arrays, the image sensor providing a raw image, a circuit configured to determine a corresponding dot in the raw image that corresponds to each pixel in a final image, and a display to receive the final image and display the final image thereon. The circuit is further configured to perform operations of locating color reference pixels in the raw image according to the corresponding dot, selecting interpolation pixels in the raw image according to the color reference pixels; and interpolating color values of the each pixel in the final image according to color values of the interpolation pixels, and interpolating color values of the each pixel in the final image according to color values of the interpolation pixels;

One of the objects, features, and advantages of the present invention is to provide techniques for efficiently processing Bayer image data to generate a final image that realistically and properly reproduce an original scene.

Other objects, features, and advantages of the present invention will become apparent upon examining the following detailed description of an embodiment thereof, taken in conjunction with the attached drawings.

### BRIEF DESCRIPTION OF THE DRAWINGS

These and other features, aspects, and advantages of the present invention will become better understood with regard to the following description, appended claims, and accompanying drawings where:

FIGS. 1a-1d show, respectively; four different ways for arranging monochrome pixels according to the Bayer color arrays;

FIG. 2 is a flowchart showing a conventional method of processing Bayer image data;

FIG. 3 is diagram showing how to select interpolation pixels in the prior art;

FIG. 4 is a flowchart or process of processing Bayer image data according to one embodiment of the present invention;

FIG. 5 is a diagram showing how to locate reference pixels;

FIG. 6 is a diagram showing how to select interpolation pixels when the reference pixel is red or blue; and

FIG. 7 is a diagram showing how to select interpolation pixels when the reference pixel is green.

### DETAILED DESCRIPTION OF THE INVENTION

The detailed description of the present invention is presented largely in terms of procedures, steps, logic blocks, processing, or other symbolic representations that directly or indirectly resemble the operations of devices or systems contemplated in the present invention. These descriptions and representations are typically used by those skilled in the art to most effectively convey the substance of their work to others skilled in the art.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments mutually exclusive of other embodiments. Further, the order of blocks in process flowcharts or diagrams or the use of sequence numbers representing one or more embodiments of the invention do not inherently indicate any particular order nor imply any limitations in the invention.

One of the aspects in the present invention is to combine the format converting operation and the zooming operation so as to decrease the calculation operations. To facilitate the description of the present invention, it is assumed that a raw image from a Bayer color arrays has a size of M×N and the final image in RGB format has a size of M′×N′. As described above, each pixel in the raw image in the Bayer format represents only one primary color, hence we need to interpolate the two missing color values for each pixel of the raw image.

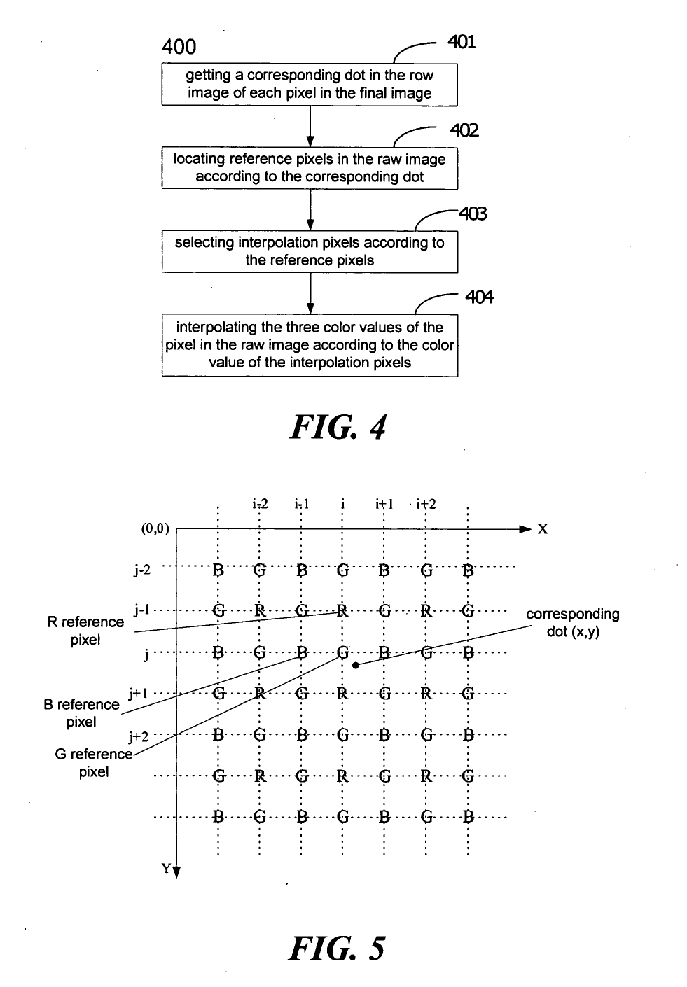

Referring now to FIG. 4, there shows a flowchart or process 400 for processing Bayer image data to generate a final image that reproduces an original scene. The process 400 may be implemented in software or hardware, or in combination of both as a method, an apparatus or a part of a system.

At 401, coordinates or a dot at (x,y) in the raw image that is correspond to a pixel at (i′,j′) in the final image can be obtained according to the following formula:
x=i′M/M′,y=j′N/N′, 0≦i′<M′, 0<j′<N′

Reference pixels in the raw image are located at 402 according to the corresponding coordinates (x,y). According to one embodiment, FIG. 5 illustrates how to locate the reference pixels in the raw image in reference to the corresponding dot at (x,y). First, a pixel at (i,j) in the raw image is located by integrating x, y downward, namely, i=└x┘,j=└y┘.

Even for the same corresponding pixel, different reference pixels may be selected to calculate different color values of the pixel at (i′,j′) in the final RGB image, due to each pixel in the raw image only representing one primary color. Hence, the color type of the corresponding pixel at (i,j) can be determined.

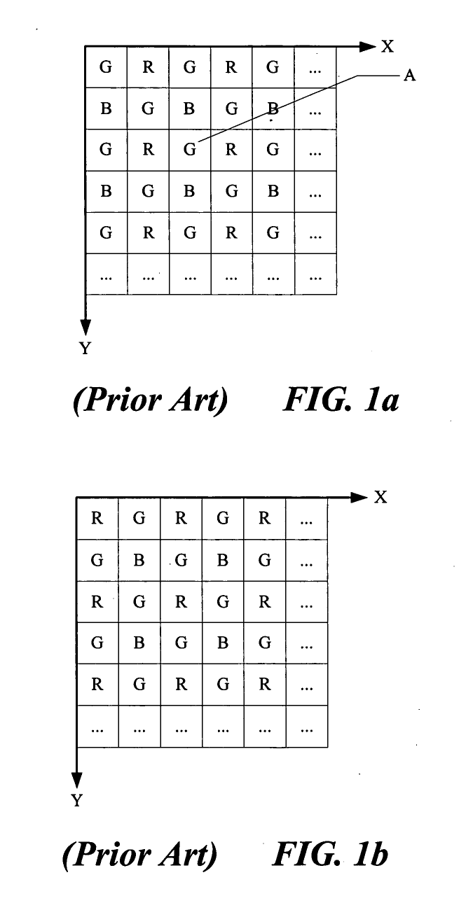

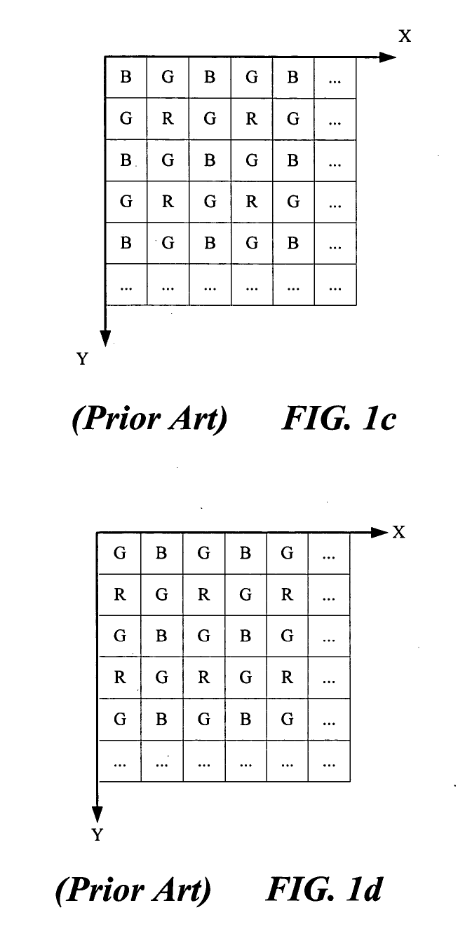

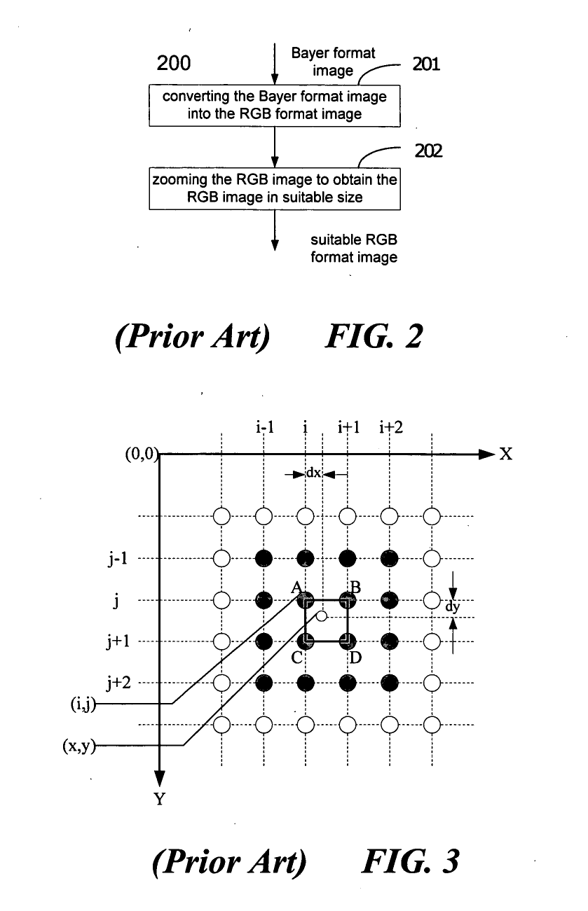

If the pixel arrangement of the raw image looks like that shown in FIG. 1(a), the color type of the pixel at (i, j) can be determined by:

$${Type}_{( i , j )} = \{ \begin{matrix}R & if ( i mod 2 = 1 \& j mod 2 = 0 ) \\ G & if ( \begin{matrix}i mod 2 = 1 \& j mod 2 = \\ 1 \vert i mod 2 = 0 \& j mod 2 = 0\end{matrix} ) \\ B & if ( i mod 2 = 0 \& j mod 2 = 1 )\end{matrix} \qquad ( 6 )$$

If the pixel arrangement of the raw image looks like that shown in FIG. 1(b), the color type of the pixel at (i,j) can be determined by:

$${Type}_{( i , j )} = \{ \begin{matrix}R & if ( i mod 2 = 0 \& j mod 2 = 0 ) \\ G & if ( \begin{matrix}i mod 2 = 1 \& j mod 2 = \\ 0 \vert i mod 2 = 0 \& j mod 2 = 1\end{matrix} ) \\ B & if ( i mod 2 = 1 \& j mod 2 = 1 )\end{matrix} \qquad ( 7 )$$

If the pixel arrangement of the raw image looks like that shown in FIG. 1(c), the color type of the pixel at (i,j) can be determined by:

$${Type}_{( i , j )} = \{ \begin{matrix}R & if ( i mod 2 = 1 \& j mod 2 = 1 ) \\ G & if ( \begin{matrix}i mod 2 = 1 \& j mod 2 = \\ 0 \vert i mod 2 = 0 \& j mod 2 = 1\end{matrix} ) \\ B & if ( i mod 2 = 0 \& j mod 2 = 0 )\end{matrix} \qquad ( 8 )$$

If the pixel arrangement of the raw image looks like that shown in FIG. 1(d), the color type of the pixel at (i,j) can be determined by:

$${Type}_{( i , j )} = \{ \begin{matrix}R & if ( i mod 2 = 0 \& j mod 2 = 1 ) \\ G & if ( \begin{matrix}i mod 2 = 1 \& j mod 2 = \\ 1 \vert i mod 2 = 0 \& j mod 2 = 0\end{matrix} ) \\ B & if ( i mod 2 = 1 \& j mod 2 = 0 )\end{matrix} \qquad ( 9 )$$

After determining the color type of the corresponding pixel at (i,j), the reference pixels are located according to the color type of the corresponding pixel. If the corresponding pixel at (i,j) is R, the pixel at (i,j) may be taken as the R reference pixel while the pixel at (i,j−1) may be taken as the G reference pixel and the pixel at (i−i,j−1) may be taken as the B reference pixel.

If the corresponding pixel at (i,j) is G, the pixel at (i,j) can be taken as the G reference pixel. If the pixel at (i,j−1) is R, the pixel at (i,j−1) can be taken as the R reference pixel, and the pixel at (i−1,j) can be taken as the B reference pixel. Otherwise, the pixel at (i+1,j) can be taken as the R reference pixel, and the pixel at (i,j−1) can be taken as the B reference pixel. For example, as shown in FIG. 5, the pixel at (i,j) is G and the pixel at (i,j−1) is R, accordingly the pixel at (i,j) is taken as the G reference pixel, the pixel (i,j−1) as the R reference pixel, the pixel (i,j−1) as the B reference pixel.

If the pixel at (i,j) is B, the pixel at (i,j) can be taken as the B reference pixel, the pixel at (i,j−1) can be taken as the G reference pixel, and the pixel at (i−1,j−1) as the R reference pixel.

At 403, interpolation pixels in the raw image are selected according to the reference pixels. Finally, the color values the pixel (i′,j′) in the final image is interpolated according to the color value of the interpolation pixels at 404.

For the reference pixels with different color types, there are different ways for selecting the interpolation pixels. As shown in FIGS. 1a-1d, a half of the total number of pixels is G, while a quarter of the total number is assigned to either R or B. Due to the arrangement of the B pixels in the Bayer color arrays similar as that of the R pixels, the ways for selecting the interpolation pixels is substantially similar.

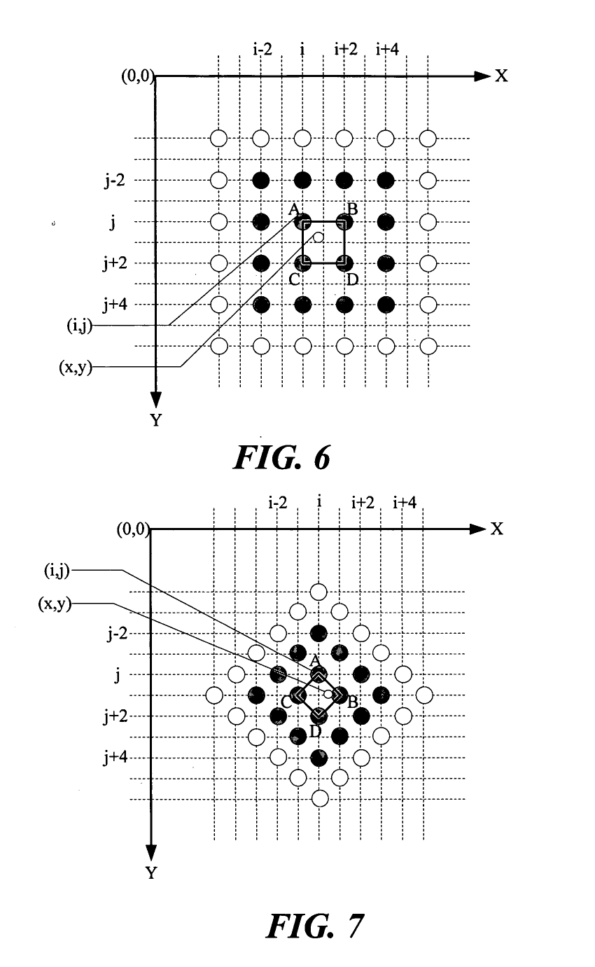

According to one embodiment, the operation for selecting the interpolation pixels can be specifically described in accordance with the reference pixel being R or B. As shown in FIG. 6, it is supposed that the pixel at (i,j) in the raw image serves as the R or B reference pixel. When the Bi-Linear method is used to calculate the color value of the pixel (i′,j′) in the final image, the four pixels A(i,j), B(i+2,j), C(i,j+2), D(i+2,j+2) in FIG. 6 can be selected as the interpolation pixels. The R or B value f′(i′,j′) of the pixel (i′,j′) is obtained by:
f′(i′,j′)=(1−dx)(1−dy)f(i,j)+dy(1−dx)f(i,j+2)+dx(1−dy)f(i+2,j)+dxdyf(i+2,j+2) (10)
where

$$dx = \frac{1}{2} ( x - i ) , dy = \frac{1}{2} ( y - j ) , 0 \leq dx , dy < 1$$

When the Bi-Cubic method is used to calculate the color value of the pixel (i′,j′) in the final image, sixteen pixels designated in grey in FIG. 6 will be selected as the interpolation pixels. The R or B value f′(i′,j′) of the pixel (i′,j′) is obtained by:

$${f}^{′} ( {i}^{′} , {j}^{′} ) = ( \begin{matrix}{\sum }_{m = - 1}^{2} {\sum }_{n = - 1}^{2} f ( i + 2 m , j + 2 n ) \\ R ( m - dx ) R ( dy - n )\end{matrix} \\ where \\ dx = \frac{1}{2} ( x - i ) , dy = \frac{1}{2} ( y - j ) , and 0 \leq dx , dy < 1 \qquad ( 11 )$$

A weighted coefficient R(x) in formula (11) is:

$$R ( x ) = \frac{1}{6} [ P {( y + 2 )}^{3} - 4 P {( y + 1 )}^{3} + 6 P {( y )}^{3} - 4 P {( y - 1 )}^{3} ] \\ wherin \\ P ( x ) = \{ \begin{matrix}x & x \geq 0 \\ 0 & x < 0\end{matrix} . \qquad ( 12 )$$

The interpolation pixel selecting operation of the G reference pixel may be the same as that of the R or B reference pixel. As shown in FIG. 6, it is supposed that the pixel A at (i,j) serves as the G reference pixel, in the Bi-Liner method, the four interpolation pixels at (i,j), (i+2,j) a (i,j+2) and (i+2,j+2) are selected. It indicates that the pixel at (i+1,j+1) is more closer than the pixel (i+2,j+2) to the corresponding dot, but it is not selected as the interpolation pixels. For this, a way to precisely select the interpolation is provided here.

As shown in FIG. 7, it is supposed that the pixel A at (i,j) is taken as the G reference pixel, the other pixels shown in FIG. 7 are all G pixels. In this embodiment, the four pixels A at (i,j), B at (i+1,j+1), C at (i−1,j+1), and D at (i,j+2) in FIG. 7 are selected as the interpolation pixels when the Bi-Liner method is provided. The G value f′(i′,j′) of the pixel (i′,j′) is obtained by:
f′(i′,j′)=(1−dx)(1−dy)f(i,j)+dy(1−dx)f(i−1,j+1)+dx(1−dy)f(i+1,j+1)+dxdyf(i,j+2) (13)
wherein dx=(x−i)/\sqrt{2} and dy=(y−j)/\sqrt{2}, 0≦dx,dy<1

If the Bi-Cubic way is used, there are sixteen pixels designated in grey in FIG. 7 that can be selected as the interpolation pixels. Depending on implementation, the formula may be different or modified in accordance with formula (11), which in one example can sum the sixteen selected pixel values and integrate the weighted coefficients. T

It can be observed that the selected interpolation pixels constitute a rectangle grid which encircles the corresponding dot therein and the reference pixel located on. A grid line of the rectangle grid shown in FIG. 61 is parallel to the X axis or the Y axis, while a grid line of the rectangle grid shown in FIG. 7 is formed at a 45° angle with the Y axis or the X axis. After three color values of all the pixels in the final image is obtained by the operations above, the final image in RGB format can be finally obtained.

The present invention has been described in sufficient details with a certain degree of particularity. It is understood to those skilled in the art that the present disclosure of embodiments has been made by way of examples only and that numerous changes in the arrangement and combination of parts may be resorted without departing from the spirit and scope of the invention as claimed. Accordingly, the scope of the present invention is defined by the appended claims rather than the foregoing description of embodiments.

What is claimed is:

1. A method for processing Bayer images, the method comprising:
receiving a raw image from a sensor with Bayer color arrays;
determining a corresponding dot in the raw image that corresponds to each pixel in a final image;
locating color reference pixels in the raw image according to the corresponding dot;
selecting interpolation pixels in the raw image according to the color reference pixels; and
interpolating color values of the each pixel in the final image according to color values of the interpolation pixels.

2. The method as claimed in claim 1, wherein each of the color reference pixels includes three primary color components, a red reference pixel, a blue reference pixel and a green reference pixel.

3. The method as claimed in claim 1, wherein the determining of the corresponding dot is performed with a zooming factor between the raw image and the final image and coordinates of the each pixel in the final image.

4. The method as claimed in claim 3, wherein the locating of the color reference pixels comprises:
obtaining a corresponding pixel in the raw image according to the corresponding dot;
determining a color type of the corresponding pixel; and
locating the red, blue and green reference pixels according to the color type of the corresponding pixel.

5. The method as claimed in claim 4, wherein, if the corresponding pixel is at (i,j) either of the corresponding pixel or one of its neighboring pixels is taken as a first reference pixel, two of its other neighboring pixels are taken, respectively, as a second and third reference pixel.

6. The method as claimed in claim 4, wherein, if the corresponding pixel at (i,j) is R, the pixel at (i,j) is taken as the red reference pixel, a pixel at (i,j−1) is taken as the green reference pixel, and a pixel at (i−1, j−1) is taken as the blue reference pixel.

7. The method as claimed in claim 1, wherein the selected interpolation pixels constitutes a rectangle grid which encircles the corresponding dot therein and the reference pixel located on.

8. The method as claimed in claim 7, wherein a grid line of the rectangle grid is parallel to rows or columns of the raw image.

9. The method as claimed in claim 7, wherein a grid line of the rectangle grid is formed at a 45° angle with respect to rows or columns of the raw image.

10. An apparatus for processing Bayer images, the apparatus comprising:
an image sensor with Bayer color arrays, the image sensor providing a raw image;
a circuit configured to determine a corresponding dot in the raw image that corresponds to each pixel in a final image; the circuit further configured to perform operations of:
locating color reference pixels in the raw image according to the corresponding dot;
selecting interpolation pixels in the raw image according to the color reference pixels; and
interpolating color values of the each pixel in the final image according to color values of the interpolation pixels;
a display to receive the final image and display the final image thereon.
